(19) United States
(12) Patent Application Publication
(10) Pub. No.: US 2008/0152534 A1
(43) Pub. Date: Jun. 26, 2008

(54) Self-assembling raman-active nanoclusters

(76) Inventors: Jingwu Zhang, San Jose, CA (US); Xing Su, Cupertino, CA (US); Lei Sun, Santa Clara, CA (US); Haovu Qin, San Jose, CA (US)

Correspondence Address: INTEL/BLAKELY, 1279 OAKMEAD PARKWAY, SUNNYVALE, CA, 94085-4040, US

(21) Appl. No.: 11/643,426

(22) Filed: Dec. 21, 2006

(51) Int. Cl. C01B 35/04; C22C 21/00; C22C 5/02; C22C 5/04; C22C 5/06; C22C 9/00

(52) U.S. Cl. 420/463; 420/466; 420/469; 420/501; 420/507; 420/528; 420/591

(57) ABSTRACT

Raman-active nanoclusters comprised of a metal and a Raman-active organic molecule incorporated therein that are capable of self-assembly are described. The Raman-active nanoclusters are capable of acting as sensitive reporters for analyte detection. A metal that enhances the Raman signal from the organic Raman-active compound is inherent in the nanocluster. A variety of organic Raman-active compounds and mixtures of compounds can be incorporated into the nanocluster.

### CROSS REFERENCE TO RELATED APPLICATIONS

The present invention is related to U.S. patent application Ser. No. 11/081,772, filed Mar. 15, 2005, now pending, U.S. patent application Ser. No. 10/940,698, filed Sep. 13, 2004, now pending, Ser. No. 10/916,710, filed Aug. 11, 2004, now pending, U.S. patent application Ser. No. 11/021,682, filed Dec. 23, 2004, now pending, U.S. patent application Ser. No. 10/830,422, filed Apr. 21, 2004, now pending, and U.S. patent application Ser. No. 10/748,336, filed Dec. 29, 2003, now pending. The present application is also related to U.S. patent applications Ser. No. 11/027,470, filed Mar. 2, 2006, now pending, Ser. No. 11/026,857, filed Dec. 30, 2004, now pending, Ser. No. 11/325,833, filed Dec. 30, 2005, now pending, and Ser. No. 11/216,112, filed Sep. 1, 2005, now pending.

### BACKGROUND OF THE INVENTION

1. Field of the Invention

Embodiments of the invention relate generally to nanoclusters that include metal particles and organic compounds and to the use of such nanoclusters in analyte detection by surface-enhanced Raman spectroscopy.

2. Background Information

The ability to detect and identify trace quantities of analytes has become increasingly important in many scientific disciplines, ranging from part per billion analyses of pollutants in sub-surface water to analysis of drugs and metabolites in blood serum. Additionally, the ability to perform assays in multiplex fashion greatly enhances the rate at which information can be acquired. Devices and methods that accelerate the elucidation of disease origin, creation of predictive and or diagnostic assays, and development of effective therapeutic treatments are valuable scientific tools. A principle challenge is to develop an identification system for a large probe set that has distinguishable components for each individual probe.

Among the many analytical techniques that can be used for chemical analyses, surface-enhanced Raman spectroscopy (SERS) has proven to be a sensitive method. A Raman spectrum, similar to an infrared spectrum, consists of a wavelength distribution of bands corresponding to molecular vibrations specific to the sample being analyzed (the analyte). Raman spectroscopy probes vibrational modes of a molecule and the resulting spectrum, similar to an infrared spectrum, is fingerprint-like in nature. As compared to the fluorescent spectrum of a molecule which normally has a single peak exhibiting a half peak width of tens of nanometers to hundreds of nanometers, a Raman spectrum has multiple structure-related peaks with half peak widths as small as a few nanometers.

To obtain a Raman spectrum, typically a beam from a light source, such as a laser, is focused on the sample generating inelastically scattered radiation which is optically collected and directed into a wavelength-dispersive spectrometer. Although Raman scattering is a relatively low probability event, SERS can be used to enhance signal intensity in the resulting vibrational spectrum. Enhancement techniques make it possible to obtain a 10⁶ to 10¹⁴ fold Raman signal enhancement.

SERS effect is attributed mainly to electromagnetic field enhancement and chemical enhancement. It has been reported that silver particle sizes within the range of 50-100 nm are most effective for SERS. Theoretical and experimental studies also reveal that metal particle junctions are the sites for efficient SERS.

### BRIEF DESCRIPTION OF THE FIGURES

FIG. 1 is a simplified diagram showing a method by which electrostatic interaction is used to build a nanoparticle comprising a cluster of smaller nanoparticles.

FIGS. 2A, B, and C provide simplified diagrams of three different exemplary nanoparticles according to embodiments of the invention.

FIG. 3 diagrams a method by which a desired charge can be placed on a nanoparticle.

FIG. 4 shows the crosslinking of polymer molecules adsorbed on a nanoparticle.

FIG. 5 shows a simplified picture of a nanoparticle cluster coated with polyamine polymers that are crosslinked with glutaraldehyde and the product is reduced with NaBH₄.

FIGS. 6A and B show two exemplary motifs for Raman label placement in a nanocluster.

FIG. 7 shows an exemplary method for introducing Raman label molecules having amine groups into a cationic polymer.

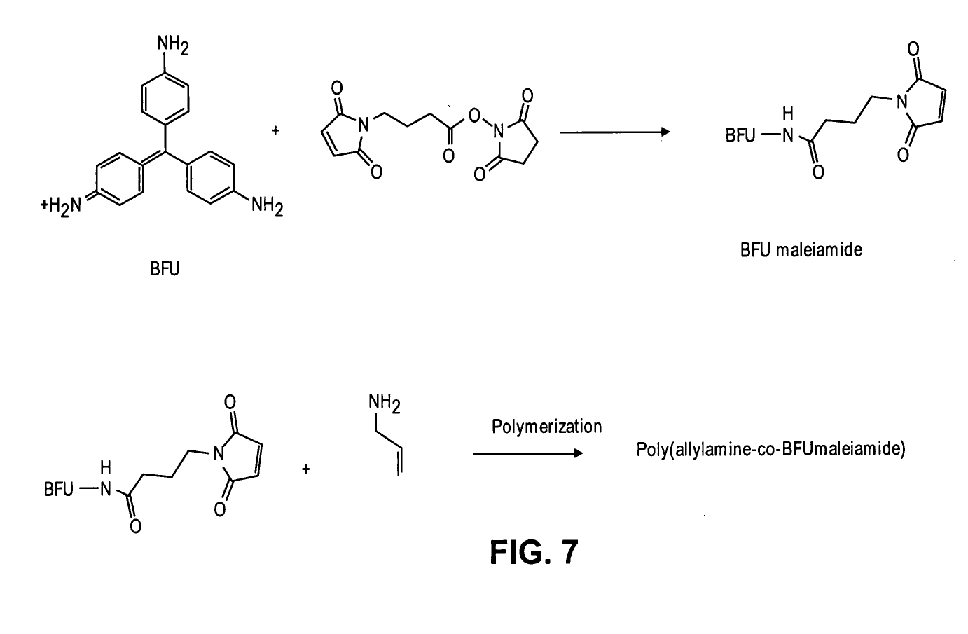

FIG. 8 graphs the Zeta potential of 70 nm silver colloid particles against the concentration of poly(2-metacryloxyethyltrimethylammonium bromide) (PQA).

FIG. 9 shows the size distribution of 24 nm silver colloid particles before and after mixing the particles with polyethyleneimine.

### DETAILED DESCRIPTION OF THE INVENTION

Composite organic inorganic nanoclusters (COINs) are sensitive Raman-active reporters that can be used in multiplexed analysis of many types of samples. Generally, COINs are composed of a metal and at least one organic Raman-active compound. Interactions between the metal of the clusters and the Raman-active compound(s) enhance the Raman signal obtained from the Raman-active compound(s) when the nanoparticle is excited by a laser. Since a large variety of organic Raman-active compounds can be incorporated into the nanoclusters, a set of Raman-active nanoclusters can be created in which each member of the set has a Raman signature unique to the set. Thus, COINs can also function as sensitive reporters for highly parallel analyte detection. Furthermore, not only are the intrinsic enhanced Raman signatures of the nanoparticles of the present invention sensitive reporters, but sensitivity may also be further enhanced by incorporating thousands of Raman labels into a single nanocluster and or attaching multiple nanoclusters to a single analyte.

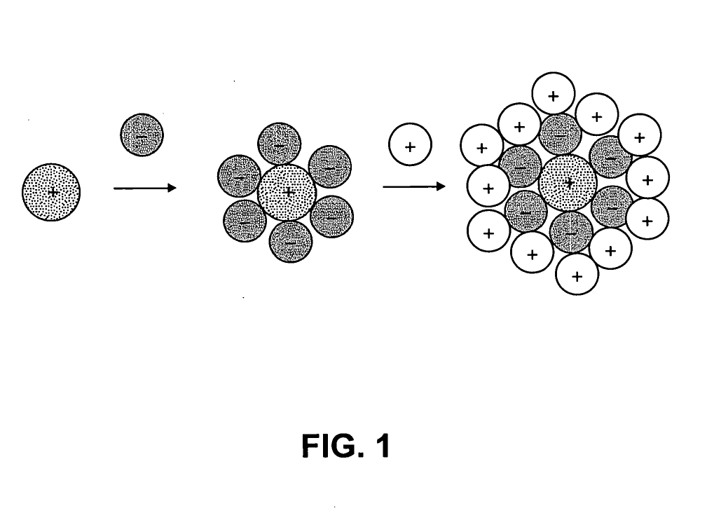

Embodiments of the present invention provide Raman-active nanoclusters having improved uniformity in size and Raman signal intensity as compared to less directed and or controlled nanocluster assembly procedures. The uniformity of particle size and signal intensity enhances, for example, the reproducibility of, the ability to quantitate, and the accuracy of analyte detection procedures. A general method for obtaining nanoclusters having an improved uniform size distribution is shown in FIG. 1. Raman-active nanoclusters are assembled in FIG. 1 according to a concentric layer-by-layer approach around a central particle. Since aliquots of particles having opposite charges (indicated by “+” and “−” in the figure) are added to the forming cluster sequentially, a cluster having layers of oppositely charged particles is allowed to form. The chemical nature of the particles used in the layers of the nanoclusters can be either the same or different. When the particles of the layers are the same, their surfaces can be modified to provide opposite charges.

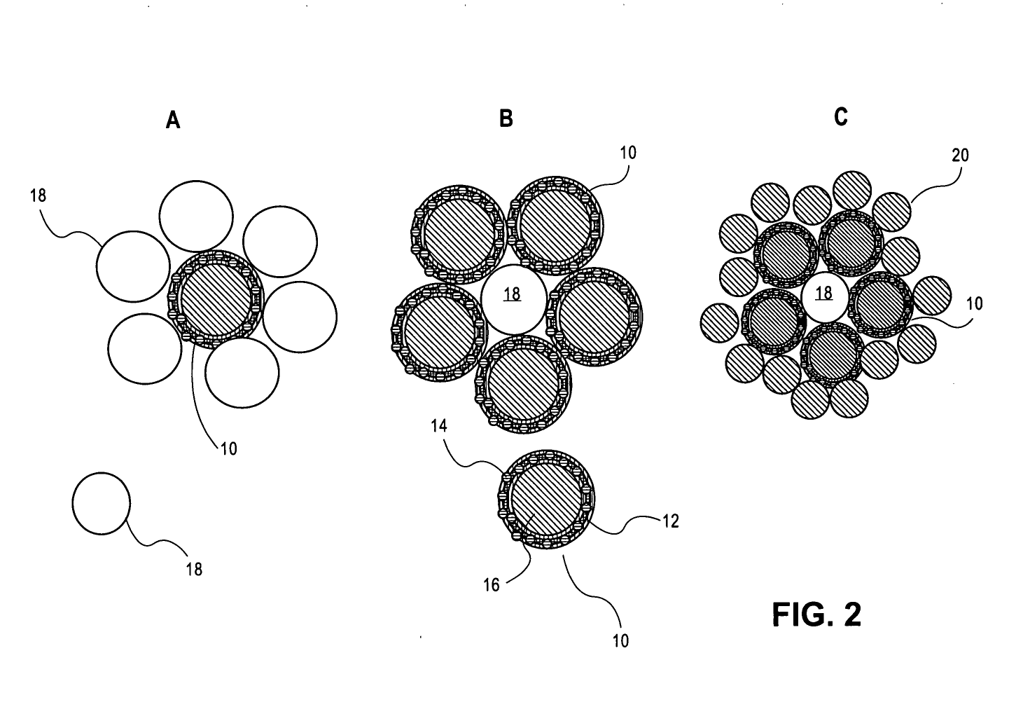

Referring now to FIGS. 2A, B, and C, simplified diagrams of three different cluster motifs are provided. The motifs shown in FIG. 2 are provided for illustration and represent several examples out of many possible Raman-active nanocluster motifs. In FIG. 2 A, a nanocluster is shown that is formed from a central nanoparticle 10 having one or more polymer layers 12 and a plurality of Raman label molecules 14 attached to a metal particle 16 and a plurality of metal nanoparticles 18 around the central polymer coated nanoparticle 10. The chemical composition of metal particles 18 may be the same or different from that of the central metal nanoparticle 16. FIG. 2B depicts a cluster formed from a central metal nanoparticle 18 surrounded by a plurality of particles 10 which are in turn comprised of a central metal particle 16, a polymer coating 12 and attached Raman labels 14. FIG. 2C shows a cluster comprised of three layers. In FIG. 2C, a cluster is comprised of a central nanoparticle 18, a first layer particles 10 comprised of a metal nanoparticle 16, an attached polymer layer 12 and a plurality of attached Raman labels 14. In general, a central metal particle may be the same or different sized than the surrounding metal particles. In addition, Raman label molecules may be linked to the central particle or the surrounding particle layer(s) and additional surrounding metal particle layers that either do have or do not have Raman labels may be added.

Particles used in certain embodiments of the invention to form nanoclusters are metal nanoparticles or coated metal nanoparticles. Metals that can be used include, for example, silver, gold, platinum, palladium, aluminum, copper, zinc, and iron. Additionally, the particles used to form nanoclusters may be comprised of more than metal. For example, the particle could be silver coated gold or vice versa.

In general, for applications using self-assembling nanoclusters as reporters for analyte detection, the average diameter of the self-assembling nanocluster should be less than about 200 nm. Typically, in analyte detection applications, self-assembling nanoclusters will range in average diameter from about 30 to about 200 nm. More preferably self-assembling nanoclusters range in average diameter from about 40 to about 200 nm, and more preferably from about 50 to about 200 nm, more preferably from about 50 to about 150 nm, and more preferably about 50 to about 100 nm.

To prepare colloidal metal nanoparticles, an aqueous solution is prepared containing suitable metal cations and a reducing agent. The components of the solution are then subject to conditions that reduce the metallic cations to form neutral, colloidal metal particles. In general, colloids are very small insoluble particles that are dispersed or suspended in a dispersion medium consisting of a phase that is different from the particle phase and either phase can be solid, liquid, or gas. In the present case, the silver colloid is a solid and the dispersion medium is a liquid, usually an aqueous solution.

The colloidal metal nanoparticles can vary in size, but are chosen to be smaller than the desired size of the resulting nanoclusters. For some applications, metal colloid particles ranging in average diameter from about 3 nm to about 80 nm are employed. Additionally, multi-metal nanoparticles may be used, such as, for example, silver nanoparticles having gold cores.

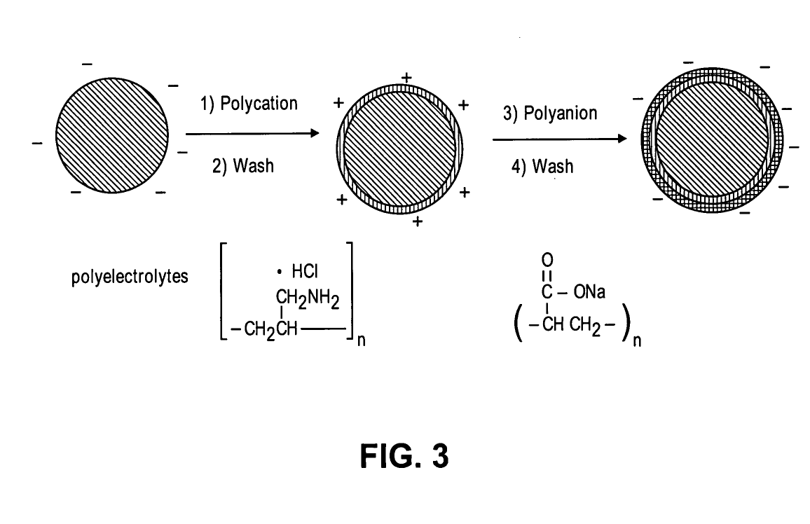

Nanoparticle surface charge reversal is achieved through the adsorption of a single layer of polyelectrolyte onto the particle surface. Large polymers can absorb onto metal particle surfaces almost irreversibly. Referring now to FIG. 3, a method is provided whereby a metal nanoparticle may be coated with one or more polymer layers. Exemplary polycation (polyamine) and polyanion (acetate) polyelectrolytes are shown in FIG. 3. By adding the desired positively charged polyelectrolyte to a solution of metal nanoparticles (having a negatively charged surface), nanoparticles having a layer of polyelectrolyte can be created. Similarly, a second layer of negatively charged polyelectrolyte, such as for example, polyacrylic acid, can be added to the nanoparticles having a first layer of polycation. Other possible polyelectrolytes include, for example, poly(ethylenimine), poly(4-vinylpyridine hydrochloride), polyaniline, polypyrrole, poly(sodium 4-styrenesulfate), poly(acrylic acid), and bio polymers, such as proteins with positive or negative surface charges, DNA and RNA (negatively charged), as well as copolymer and block polymers such as poly(ethylene-co-methacrylic acid) and poly(maleic acid-co-olefin).

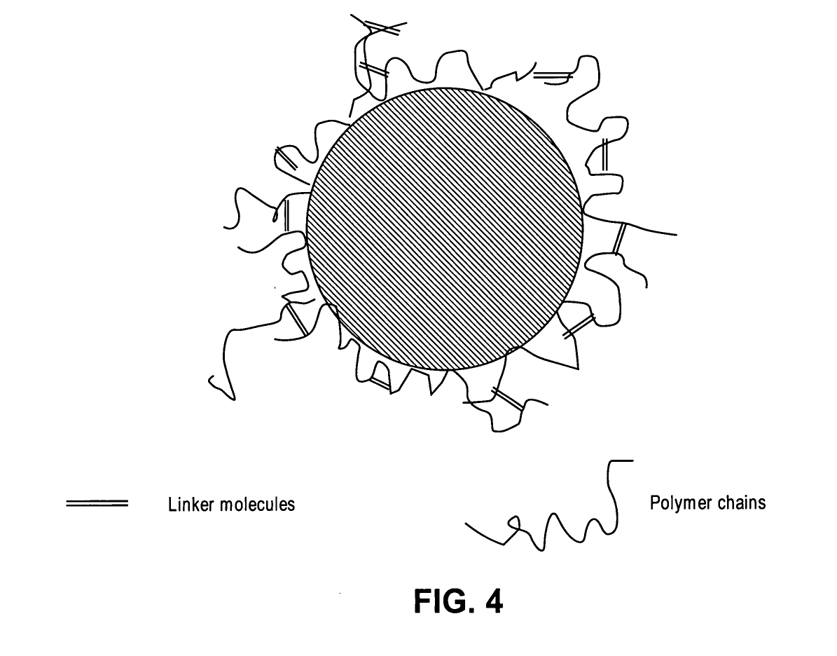

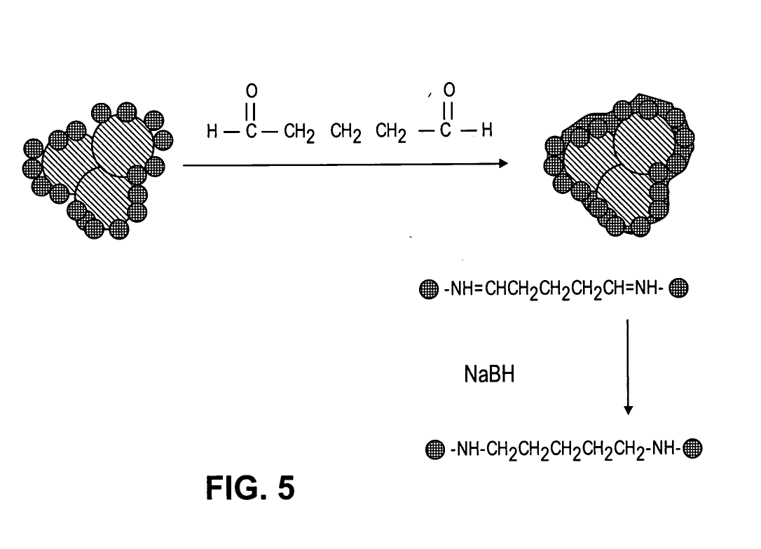

In further embodiments, polyelectrolyte layers having enhanced stability are provided. Functional groups in the electrolytes can be crosslinked so that the particles are encaged. An exemplary nanocluster (shown in simplified form as a sphere) having surface-attached crosslinked polymer chains is shown in FIG. 4. For example, the negatively charged silver particles may be coated with a polycation (e.g. polyethyleneimine or polyallyalamine) and then a portion of the amine groups are crosslinked with glutaraldehyde. As shown in the exemplary reaction in FIG. 5, after crosslinking with glutaraldehyde, the crosslinked polymer is reduced with sodium borohydride. In the reaction to create crosslinked polymers on the nanocluster surface, some of amine groups remain unreacted to provide the particle with positive charge. In further embodiments, a copolymer having different functional groups (e.g. amine and tertiary amine) is selected so that only amine groups are converted to the amide group and the tertiary amine groups remain to provide positive charges to the particles.

It is possible to create a large number of different molecular identifiers from the Raman-active nanoclusters of the present invention. Raman-active nanoclusters be created with different Raman labels, and nanoclusters may also be created having different mixtures of Raman labels and also different ratios of Raman labels within the mixtures. Thus, it is possible to create a large number of different tags for analyte detection. Table 1 provides examples of the types of organic compounds that can be used as Raman labels in embodiments of the invention. In general, Raman-active organic compound refers to an organic molecule that produces a unique SERS spectrum (or signature) in response to excitation by a laser. Typically the Raman-active compound has a molecular weight less than about 500 Daltons.

TABLE 1

| No. | Name | Structure |
|---|---|---|
| 1 | 8-Aza-adenine | 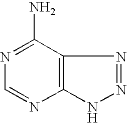 |
| 2 | N-Benzoyladenine | 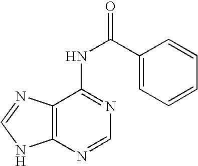 |
| 3 | 2-Mercapto-benzimidazole | 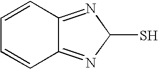 |
| 4 | 4-Amino-pyrazolo[3,4-d]pyrimidine | 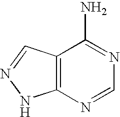 |
| 5 | Zeatin | 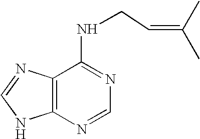 |
| 6 | Methylene Blue | 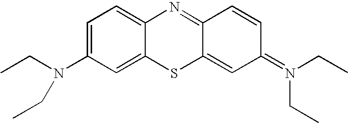 |
| 7 | 9-Amino-acridine | 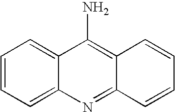 |
| 8 | Ethidium Bromide | 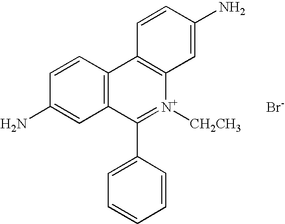 |
| 9 | Bismarck Brown Y | 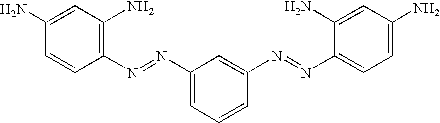 |
| 10 | N-Benzyl-aminopurine | 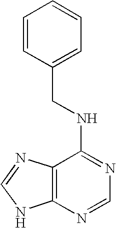 |
| 11 | Thionin acetate | 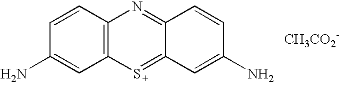 |
| 12 | 3,6-Diaminoacridine | 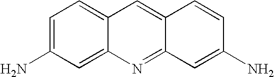 |
| 13 | 6-Cyanopurine | 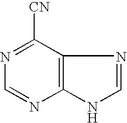 |
| 14 | 4-Amino-5-imidazole-carboxamidehydrochloride | 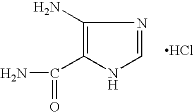 |
| 15 | 1,3-Diiminoisoindoline | 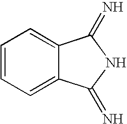 |
| 16 | Rhodamine 6G | 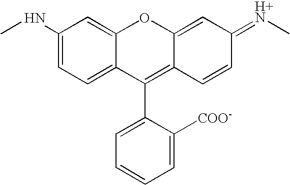 |
| 17 | Crystal Violet | 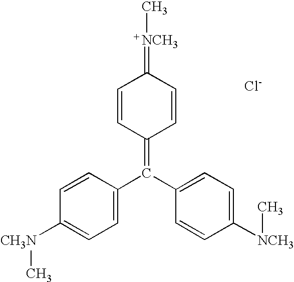 |
| 18 | Basic Fuchsin | 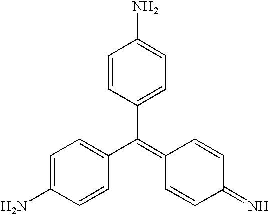 |
| 19 | Aniline Blue Diammonium salt | 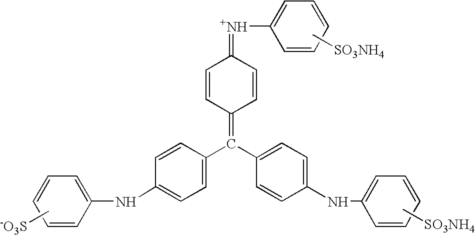 |
| 20 | N-[(3-(Anilinomethylene)-2-chloro-1-cyclohexen-1-yl)methylene]anilinemonohydrochloride | 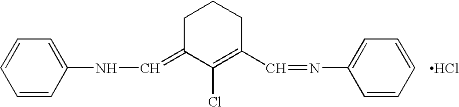 |
| 21 | O-(7-Azabenzotriazol-1-yl)-N,N,N′,N′-tetramethyluroniumhexafluorophosphate | 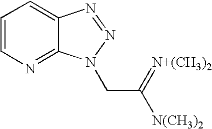 |
| 22 | 9-Aminofluorene hydrochloride | 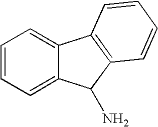 |
| 23 | Basic Blue | 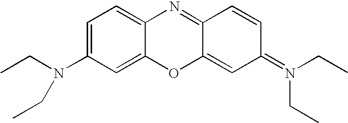 |
| 24 | 1,8-Diamino-4,5-dihydroxyanthraquinone | 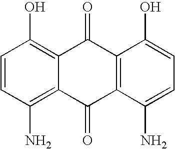 |
| 25 | Proflavine hemisulfate salt hydrate | 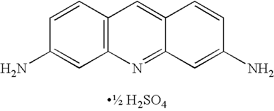 |
| 26 | 2-Amino-1,1,3-propenetricarbonitrile | 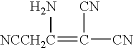 |
| 27 | Variamine Blue RT salt | 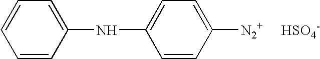 |
| 28 | 4,5,6-Triaminopyrimidine sulfate salt | 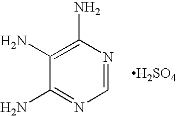 |
| 29 | 2-Amino-benzothiazole | 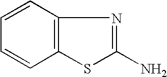 |
| 30 | Melamine | 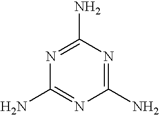 |
| 31 | 3-(3-Pyridylmethylaxnino)Propionitrile | 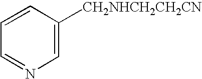 |
| 32 | Silver(I) Sulfadiazine | 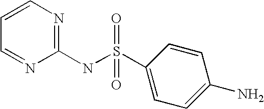 |
| 33 | Acriflavine | 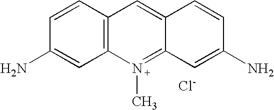 |
| | | 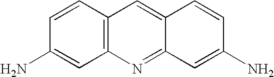 |
| 34 | 4-Amino-6-mercaptopyrazolo[3,4-d]pyrimidine | 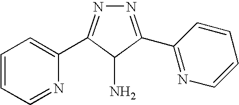 |
| 35 | 2-Aminopurine | 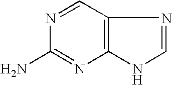 |
| 36 | Adenine Thiol | 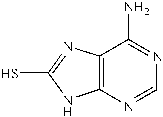 |
| 37 | Fluoroadenine | 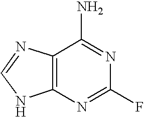 |
| 38 | 6-Mercaptopurine | 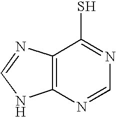 |
| 39 | 4-Amino-6-mercapyopyrazolo[3,4-d]pyrimidine | 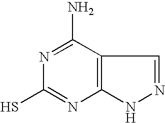 |
| 41 | Rhodamine 110 | 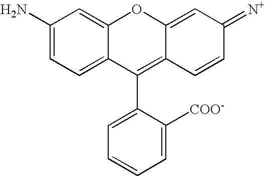 |
| 42 | Adenine | 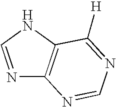 |
| 43 | 5-Amino-2-mercaptobenzimidazole | 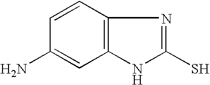 |

Some compounds that give strong regular Raman signals in solution do not yield as strong a signal when incorporated in a nanocluster. Further, within a particular compound, vibration modes that give strong regular Raman peaks in solution do not necessarily produce strong peaks in metal nanoclusters. Strong signals from nanoparticle reporters are desirable in applications such as the detection of analytes that are present at low concentrations. It was found that the organic compounds shown in Table 2 produced strong Raman signals upon incorporation into metal nanoclusters, such as for example, COINs.

TABLE 2

| No. | Name | Structure | |
|---|---|---|---|
| 44 | Acridine Orange Hydrochloride | 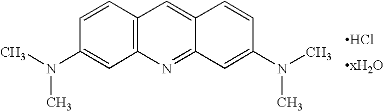 | |
| 45 | Cresyl Violate Acetate | 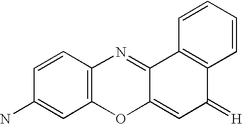 | |
| 46 | Acriflavine Neutral | 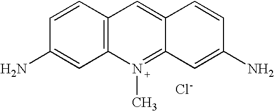 | |
| | | 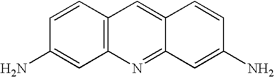 | |
| 47 | Dimidium Bromide | 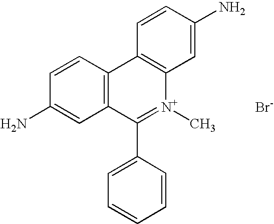 | |
| 48 | 5,10,15,20-Tetrakis(N-methyl-4-pyridinio)porphyrin Tetra(p-toluenesulfonate) | 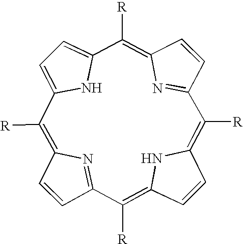 | 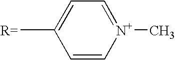 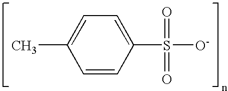 |
| 49 | 5,10,15,20-Tetrakis(4-trimethylaminophenyl)porphyrinTetra(p-toluenesulfonate) | 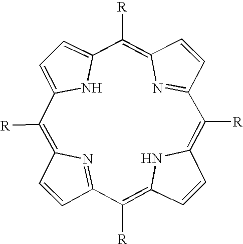 | 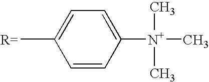 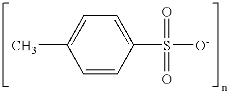 |

| | | |
|---|---|---|
| 50 | 3,5-Diaminoacridine Hydrochloride | 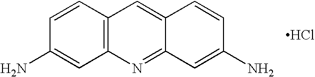 |
| 51 | Propidium Iodide (3,8-diamino-5-(3-diethylaminopropyl)-6-phenylphenanthridinium iodidemethiodide) | 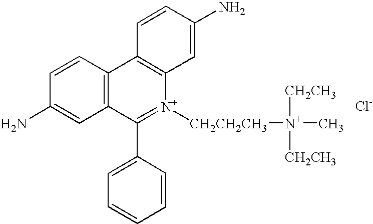 |
| 52 | Trans-4-[4-(dimethylamino)styryl]-1-methylpyridinium iodide | 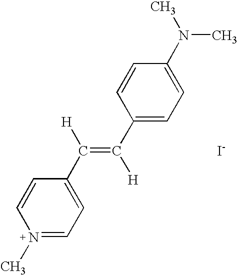 |
| 53 | 4-((4-(dimehtylamino)phenyl)azo)benzoicacid, succinimidyl ester | 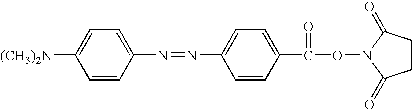 |

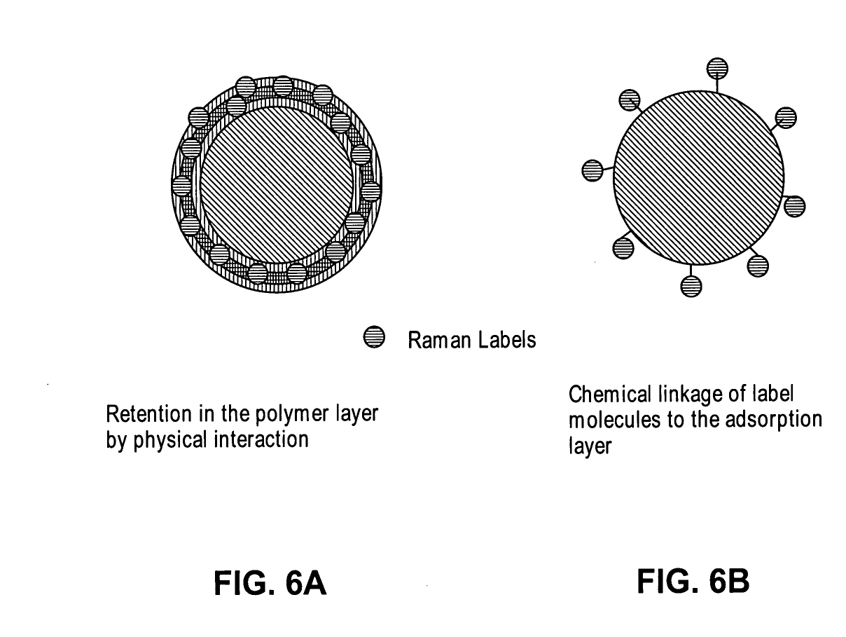

Referring now to FIG. 6, two exemplary approaches are shown for the introduction of Raman-active molecules into a nanocluster of metal particles. The first exemplary method shown in FIG. 6A is by physical absorption of the Raman label molecules into a polymer layer. When a relatively thick polymer layer is present, the label molecules can be absorbed and or retained in the layer through electrostatic and hydrophobic interactions. Polymer chains with different structures can be selected to favor the retention of a given type of Raman label molecule. As shown in FIG. 6B, chemical reactions can also be used to link the Raman label molecules to the adsorption layer. The Raman label molecules will be first converted into reactive forms, if necessary, to react with the functional groups of various polymers. For example, for a polymer having an amine functional group (such as, for example, polyallylamine), the Raman label can be attached through, for example, a NHS ester group, an isothiocyanate group, and or through sulfyl halide groups. In the case of a polymer presenting carboxylic acid groups (such as for example, polyacrylic acid), a Raman label can be attached through carbodiimide functional group on the label. For polymers presenting thiol groups (such as for example, proteins), Raman labels can be attached through, for example, a haloacetyl group, a maleimide group, a disulphide group, and or a vinyl sulfone group. For polymers presenting a hydroxy group (such as for example polyvinyl alcohol), Raman labels can be attached, for example, through an isothiocyanate or a sulfonyl halide group. For polysaccharides, Raman labels can be attached, for example, through an amide functional group, followed by oxidation of the sugar.

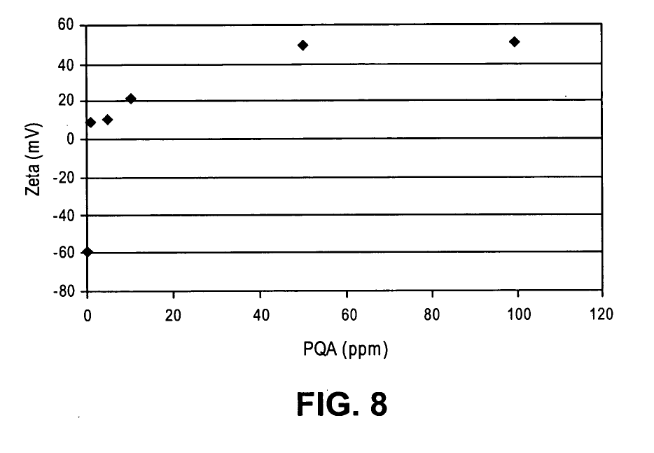

Further, Raman label molecules may be introduced to the adsorption layer through polymerization or copolymerization. For example, a Raman label such as pyridine can be incorporated into a monomer, then polymerized to poly(4-vinylpyridine), which can be protonated with acid to form a positively charged polymer. In another example, shown in FIG. 8, a NH₂-containing label such as BFU (Basic Fuchsin) is treated with GMBS (N-maleimidobutyryloxysuccinimide ester) to couple a maleicamide group to the label, then the derivatized label is co-polymerized with another monomer such as allylamine to yield a cationic polymer loaded with BFU.

Raman-active nanoclusters may be stabilized and or functionalized with different types of coating layers and combinations of layers. Typical coatings or layers useful in embodiments of the present invention include coatings such as polymer layers, protein layers, silica layers, hematite layers, organic layers, and organic thiol-containing layers. Many of the layers, such as the adsorption layers and the organic layers provide additional mechanisms for probe attachment. For instance, layers presenting carboxylic acid functional groups allow the covalent coupling of a biological probe, such as an antibody, through an amine group on the antibody.

An adsorption layer that coats the Raman-active nanocluster can be comprised of, for example, an organic molecule or a polymer, such as for example, a block co-polymer or a biopolymer, such as for example, a protein, peptide, or a polysaccharide. The adsorption layer, in some cases, stabilizes the nanocluster and can also provide bio-compatible functional surfaces for probe attachment and aid in the prevention of non-specific binding to the nanocluster. For example, suitable polymeric adsorption layers include, polyacrylamide, partially hydrolyzed polyacrylamide, polyacrylic acid, polyacrylamide acrylic acid copolymers, polybutadiene-maleic acid copolymers, polyglycol-poly(L-amino acid) copolymers, polyethylenimine (branched or unbranched), PEG-PE (polyethylene glycol-phosphoethanolamine), poly(L-lysine hydrobromide), PGUA (polygalacturonic acid), or algenic acid. A polymer adsorption layer can be prepared by dissolving the polymer in an aqueous solution containing COINs and allowing the polymer to associate with the surface of the COINs. Suitable proteins for coating nanoclusters include non-enzymatic soluble globular or fibrous proteins. For applications involving molecular detection, the protein should be chosen so that it does not interfere with a detection assay, in other words, the proteins should not also function as competing or interfering probes in a user-defined assay. By non-enzymatic proteins is meant molecules that do not ordinarily function as biological catalysts. Examples of suitable proteins include avidin, streptavidin, bovine serum albumen (BSA), transferrin, insulin, soybean protein, casine, gelatine, and the like, and mixtures thereof. The bovine serum albumen layer affords several potential functional groups, such as, carboxylic acids, amines, and thiols, for further functionalization or probe attachment. Optionally, the protein layer can be cross-linked with EDC, or with glutaraldehyde followed by reduction with sodium borohydride.

Further, Raman-active nanoclusters can be coated with hematite (Fe₂O₃). The hematite coating can comprise a coating of iron oxide particles. Positively charged hematite particles will coat nanoclusters, for example, through coulombic interactions. Hematite-coated nanoclusters may be further functionalized with additional coatings. For example, coatings having carboxylic acid functional groups will tend to attach to the hematite particles. For example, a hematite-coated nanocluster may be further modified with a coating of polyacrylic acid, PGUA (polygalacturonic acid), or algenic acid.

Raman-active nanoclusters optionally may be coated with a layer of silica. Silica deposition is initiated from a supersaturated silica solution, followed by growth of a silica layer through ammonia-catalyzed hydrolysis of tetraethyl orthosilicate (TEOS). Raman-active nanoclusters can be coated with silica and functionalized, for example, with an organic amine-containing group. A silver nanocluster or silver- or gold-coated nanocluster can be coated with a layer of silica via the procedure described in V. V. Hardikar and E. Matijevic, J. Colloid Interface Science, 221:133-136 (2000). Additionally, silica-coated Raman-active nanoclusters are readily functionalized using standard silica chemistry. For example, a silica-coated Raman-active nanoclusters can be derivatized with (3-aminopropyl)triethoxysilane to yield a silica coated Raman-active nanoclusters that presents an amine group for further coating, layering, modification, or probe attachment. See, for example, Wong, C., Burgess, J., Ostafin, A., “Modifying the Surface Chemistry of Silica Nano-Shells for Immunoassays,” Journal of Young Investigators, 6:1 (2002), and Ye, Z., Tan, M., Wang, G., Yuan, J., “Preparation, Characterization, and Time-Resolved Fluorometric Application of Silica-Coated Terbium (III) Fluorescent Nanoparticles,” Anal. Chem., 76:513 (2004). Additional layers or coatings that may be layered on a silica coating include the coatings and layers exemplified herein.

Raman-active nanoclusters can be complexed to a selected molecular analyte through a probe attached to the nanocluster that is specific for the selected analyte. In general, a probe is a molecule that is able to specifically bind an analyte and, in certain embodiments, exemplary probes are antibodies, antigens, polynucleotides, oligonucleotides, carbohydrates, proteins, cofactors, receptors, ligands, peptides, inhibitors, activators, hormones, cytokines, and the like. For example, the analyte can be a protein and the nanocluster is complexed to the analyte through an antibody that specifically recognizes the protein analyte of interest.

In some embodiments, a probe is an antibody. As used herein, the term antibody is used in its broadest sense to include polyclonal and monoclonal antibodies, as well as antigen binding fragments of such antibodies. An antibody useful in the present invention, or an antigen binding fragment thereof, is characterized, for example, by having specific binding activity for an epitope of an analyte. An antibody, for example, includes naturally occurring antibodies as well as non-naturally occurring antibodies, including, for example, single chain antibodies, chimeric, CDR-grafted, bifunctional, and humanized antibodies, as well as antigen-binding fragments thereof. Such non-naturally occurring antibodies can be constructed using solid phase peptide synthesis, can be produced recombinantly, or can be obtained, for example, by screening combinatorial libraries consisting of variable heavy chains and variable light chains.

Additionally, a probe can be a polynucleotide. A nanocluster-labeled oligonucleotide probe can be used in a hybridization reaction to detect a target polynucleotide. Polynucleotide is used broadly herein to mean a sequence of deoxyribonucleotides or ribonucleotides that are linked together by a phosphodiester bond. Generally, an oligonucleotide useful as a probe or primer that selectively hybridizes to a selected nucleotide sequence is at least about 10 nucleotides in length, usually at least about 15 nucleotides in length, for example between about 15 and about 50 nucleotides in length. Polynucleotide probes are particularly useful for detecting complementary polynucleotides in a biological sample and can also be used for DNA sequencing by pairing a known polynucleotide probe with a known Raman-active signal made up of a combination of Raman-active organic compounds as described herein.

A polynucleotide can be RNA or DNA, and can be a gene or a portion thereof, a cDNA, a synthetic polydeoxyribonucleic acid sequence, or the like, and can be single stranded or double stranded, as well as a DNA/RNA hybrid. In various embodiments, a polynucleotide, including an oligonucleotide (for example, a probe or a primer) can contain nucleoside or nucleotide analogs, or a backbone bond other than a phosphodiester bond. In general, the nucleotides comprising a polynucleotide are naturally occurring deoxyribonucleotides, such as adenine, cytosine, guanine, or thymine linked to 2′-deoxyribose, or ribonucleotides such as adenine, cytosine, guanine, or uracil linked to ribose. However, a polynucleotide or oligonucleotide also can contain nucleotide analogs, including non-naturally occurring synthetic nucleotides or modified naturally occurring nucleotides. One example of an oligomeric compound or an oligonucleotide mimetic that has been shown to have good hybridization properties is referred to as a peptide nucleic acid (PNA). In PNA compounds, the sugar-backbone of an oligonucleotide is replaced with an amide containing backbone, for example an aminoethylglycine backbone. In this example, the nucleobases are retained and bound directly or indirectly to an aza nitrogen atom of the amide portion of the backbone. PNA compounds are disclosed in Nielsen et al., Science, 254:1497-15 (1991), for example.

The covalent bond linking the nucleotides of a polynucleotide generally is a phosphodiester bond. However, the covalent bond also can be any of a number of other types of bonds, including a thiodiester bond, a phosphorothioate bond, a peptide-like amide bond or any other bond known to those in the art as useful for linking nucleotides to produce synthetic polynucleotides. The incorporation of non-naturally occurring nucleotide analogs or bonds linking the nucleotides or analogs can be particularly useful where the polynucleotide is to be exposed to an environment that can contain nucleolytic activity, including, for example, a tissue culture medium or upon administration to a living subject, since the modified polynucleotides can be less susceptible to degradation.

Raman-active nanoparticles can be coupled with probes through biotin-avidin coupling. For example, avidin or streptavidin (or an analog thereof) can be adsorbed to the surface of the nanoparticle and a biotin-modified probe contacted with the avidin or streptavidin-modified surface forming a biotin-avidin (or biotin-streptavidin) linkage. As discussed above, optionally, avidin or streptavidin may be adsorbed in combination with another protein, such as BSA, and/or optionally crosslinked. In addition, for nanoparticles having a functional layer that includes a carboxylic acid or amine functional group, probes having a corresponding amine or carboxylic acid functional group can be attached through water-soluble carbodiimide coupling reagents, such as EDC (1-ethyl-3-(3-dimethyl aminopropyl)carbodiimide), which couples carboxylic acid functional groups with amine groups. Further, functional layers and probes can be provided that possess reactive groups such as, esters, hydroxyl, hydrazide, amide, chloromethyl, aldehyde, epoxy, tosyl, thiol, and the like, which can be joined through the use of coupling reactions commonly used in the art. For example, Aslam, M. and Dent, A., Bioconjugation: Protein Coupling Techniques for the Biomedical Sciences, Grove's Dictionaries, Inc., (1998) provides additional methods for coupling biomolecules, such as, for example, thiol maleimide coupling reactions, amine carboxylic acid coupling reactions, amine aldehyde coupling reactions, biotin avidin (and derivatives) coupling reactions, and coupling reactions involving amines and photoactivatable heterobifunctional reagents.

Nucleotides attached to a variety of tags may be commercially obtained (for example, from Molecular Probes, Eugene, Oreg.; Quiagen (Operon), Valencia, Calif.; and IDT (Integrated DNA Technologies), Coralville, Iowa) and incorporated into oligonucleotides or polynucleotides. Oligonucleotides may be prepared using commercially available oligonucleotide synthesizers (for example, Applied Biosystems, Foster City, Calif.). Additionally, modified nucleotides may be synthesized using known reactions, such as for example, those disclosed in, Nelson, P., Sherman-Gold, R., and Leon, R., “A New and Versatile Reagent for Incorporating Multiple Primary Aliphatic Amines into Synthetic Oligonucleotides,” Nucleic Acids Res., 17:7179-7186 (1989) and Connolly, B., Rider, P., “Chemical Synthesis of Oligonucleotides Containing a Free Sulfhydryl Group and Subsequent Attachment of Thiol Specific Probes,” Nucleic Acids Res., 13:4485-4502 (1985). Alternatively, nucleotide precursors may be purchased containing various reactive groups, such as biotin, hydroxyl, sulfhydryl, amino, or carboxyl groups. After oligonucleotide synthesis, nanocluster labels may be attached using standard chemistries. Oligonucleotides of any desired sequence, with or without reactive groups for nanocluster attachment, may also be purchased from a wide variety of sources (for example, Midland Certified Reagents, Midland, Tex.).

An analyte can be any molecule or compound in the solid, liquid, gaseous or vapor phase. By gaseous or vapor phase analyte is meant a molecule or compound that is present, for example, in the headspace of a liquid, in ambient air, in a breath sample, in a gas, or as a contaminant in any of the foregoing. It will be recognized that the physical state of the gas or vapor phase can be changed for example, by pressure, temperature as well as by affecting surface tension of a liquid by the presence of or addition of salts.

The analyte can be comprised of a member of a specific binding pair (sbp) and may be a monovalent ligand (monoepitopic) or polyvalent ligand (polyepitopic), usually antigenic or haptenic, and is a single compound or plurality of compounds which share at least one common epitopic or determinant site. The analyte can be derived from a cell such as bacteria or a cell bearing a blood group antigen such as A, B, D, etc., or an HLA antigen or a microorganism, for example, bacterium, fungus, protozoan, prion, or virus. In certain aspects of the invention, the analyte is charged. A biological analyte could be, for example, a protein, a carbohydrate, or a nucleic acid.

The nanoparticles of the present invention may be used to detect the presence of a particular target analyte, for example, a protein, enzyme, polynucleotide, carbohydrate, antibody, or antigen. The nanoparticles may also be used to screen bioactive agents, such as, drug candidates, for binding to a particular target or to detect agents like pollutants. As discussed above, any analyte for which a probe moiety, such as a peptide, protein, or aptamer, may be designed can be used in combination with the disclosed nanoparticles.

Molecular analytes include antibodies, antigens, polynucleotides, oligonucleotides, proteins, enzymes, polypeptides, polysaccharides, cofactors, receptors, ligands, and the like. The analyte may be a molecule found directly in a sample such as a body fluid from a host. The sample can be examined directly or may be pretreated to render the analyte more readily detectible. Furthermore, the analyte of interest may be determined by detecting an agent probative of the analyte of interest such as a specific binding pair member complementary to the analyte of interest, whose presence will be detected only when the analyte of interest is present in a sample. Thus, the agent probative of the analyte becomes the analyte that is detected in an assay. The body fluid can be, for example, urine, blood, plasma, serum, saliva, semen, stool, sputum, cerebral spinal fluid, tears, mucus, and the like. Methods for detecting target nucleic acids are useful for detection of infectious agents within a clinical sample, detection of an amplification product derived from genomic DNA or RNA or message RNA, or detection of a gene (cDNA) insert within a clone. Detection of the specific Raman label on the captured nanocluster labeled oligonucleotide probe identifies the nucleotide sequence of the oligonucleotide probe, which in turn provides information regarding the nucleotide sequence of the target polynucleotide.

In addition, the detection target can be any type of animal or plant cell, or unicellular organism. For example, an animal cell could be a mammalian cell such as an immune cell, a cancer cell, a cell bearing a blood group antigen such as A, B, D, etc., or an HLA antigen, or virus-infected cell. Further, the target cell could be a microorganism, for example, bacterium, algae, or protozoan. The molecule bound by the probe is present on the surface of the cell and the cell is detected by the presence of a known surface feature (analyte) through the complexation of a Raman-active nanocluster to the target cell-surface feature. In general, cells can be analyzed for one or more surface features through the complexation of at least one uniquely labeled nanocluster to a known surface feature of a target cell. Additional surface features can be detected through the complexation of a differently labeled nanocluster to a second known surface feature of the target cell, or the complexation of two differently labeled Raman-active nanoclusters to a second and third surface feature, and so on. One or more cells can be analyzed for the presence of a surface feature through the complexation of a uniquely labeled nanocluster to a known surface feature of a target cell.

Cell surface targets include molecules that are found attached to or protruding from the surface of a cell, such as, proteins, including receptors, antibodies, and glycoproteins, lechtins, antigens, peptides, fatty acids, and carbohydrates. The cellular analyte may be found, for example, directly in a sample such as fluid from a target organism. The sample can be examined directly or may be pretreated to render the analyte more readily detectible. The fluid can be, for example, urine, blood, plasma, serum, saliva, semen, stool, sputum, cerebral spinal fluid, tears, mucus, and the like. The sample could also be, for example, tissue from a target organism.

In the practice of embodiments of the present invention, a Raman spectrometer can be part of a detection unit designed to detect and quantify nanoparticles of the present invention by Raman spectroscopy. Methods for detection of Raman labeled analytes, for example nucleotides, using Raman spectroscopy are known in the art. (See, for example, U.S. Pat. Nos. 5,306,403; 6,002,471; 6,174,677). A non-limiting example of a Raman detection unit is disclosed in U.S. Pat. No. 6,002,471. An excitation beam is generated by either a frequency doubled Nd:YAG laser at 532 nm wavelength or a frequency doubled Ti:sapphire laser at 365 nm wavelength. Pulsed laser beams or continuous laser beams may be used. The excitation beam passes through confocal optics and a microscope objective, and is focused onto the flow path and/or the flow-through cell. The Raman emission light from the labeled nanoparticles is collected by the microscope objective and the confocal optics and is coupled to a monochromator for spectral dissociation. The confocal optics includes a combination of dichroic filters, barrier filters, confocal pinholes, lenses, and mirrors for reducing the background signal. Standard full field optics can be used as well as confocal optics. The Raman emission signal is detected by a Raman detector, which includes an avalanche photodiode interfaced with a computer for counting and digitization of the signal.

Another example of a Raman detection unit is disclosed in U.S. Pat. No. 5,306,403, including a Spex Model 1403 double-grating spectrophotometer with a gallium-arsenide photomultiplier tube (RCA Model C31034 or Burle Industries Model C3103402) operated in the single-photon counting mode. The excitation source includes a 514.5 nm line argon-ion laser from SpectraPhysics, Model 166, and a 647.1 nm line of a krypton-ion laser (Innova 70, Coherent).

Alternate excitation sources include a nitrogen laser (Laser Science Inc.) at 337 nm and a helium-cadmium laser (Liconox) at 325 nm (U.S. Pat. No. 6,174,677), a light emitting diode, an Nd:YLF laser, and/or various ions lasers and/or dye lasers. The excitation beam may be spectrally purified with a bandpass filter (Corion) and may be focused on the flow path and/or flow-through cell using a 6× objective lens (Newport, Model L6X). The objective lens may be used to both excite the Raman-active organic compounds of the Raman-active nanoclusters and to collect the Raman signal, by using a holographic beam splitter (Kaiser Optical Systems, Inc., Model HB 647-26N18) to produce a right-angle geometry for the excitation beam and the emitted Raman signal. A holographic notch filter (Kaiser Optical Systems, Inc.) may be used to reduce Rayleigh scattered radiation. Alternative Raman detectors include an ISA HR-320 spectrograph equipped with a red-enhanced intensified charge-coupled device (RE-ICCD) detection system (Princeton Instruments). Other types of detectors may be used, such as Fourier-transform spectrographs (based on Michaelson interferometers), charged injection devices, photodiode arrays, InGaAs detectors, electron-multiplied CCD, intensified CCD and/or phototransistor arrays.

Any suitable form or configuration of Raman spectroscopy or related techniques known in the art may be used for detection of the nanoparticles of the present invention, including but not limited to normal Raman scattering, resonance Raman scattering, surface enhanced Raman scattering, surface enhanced resonance Raman scattering, coherent anti-Stokes Raman spectroscopy (CARS), stimulated Raman scattering, inverse Raman spectroscopy, stimulated gain Raman spectroscopy, hyper-Raman scattering, molecular optical laser examiner (MOLE) or Raman microprobe or Raman microscopy or confocal Raman microspectrometry, three-dimensional or scanning Raman, Raman saturation spectroscopy, time resolved resonance Raman, Raman decoupling spectroscopy or UV-Raman microscopy.

Raman signatures from Raman-active nanoclusters can be analyzed, for example, using data signature and peak analysis through peak fitting. Scanned data were analyzed for signature profiles such as Raman peak intensities and locations as well as peak width. The data were analyzed using peak and curve fitting algorithms to identify statistically the most likely parameters (such as for example, wave number, intensity, peak width, and associated baseline values) that come from control experiments, such as for example, signals from water, solvent, the substrate, and or system noise. Raman peak intensities were normalized to methanol's first main peak and, where required, also further normalized to label concentrations.

### EXAMPLES

Synthesis of Silver Seed Particles: 50 mL of a solution (in deionized water (NANOpure Infinity, Barstead)) containing 8 mM Na₃Citrate, 0.6 mM NaBH₄ (freshly prepared), and 2 mM NaOH was added to 50 mL of 4 mM AgNO₃ (in deionized water (NANOpure Infinity, Barstead)). The resulting mixture was covered and stirred vigorously for 5 seconds. The resulting silver seed particles were stored in the dark at room temperature.

Preparation of 24 nm Silver Particles: Prepare 12 nm silver seed particles one to several days before use in preparation of 24 nm silver particles. Select starting silver seed particles having a Z=11+1 nm and a PDI of less than 0.25. Allow the seed particles to age in the dark. 0.28 mL of 0.500 M AgNO₃ solution and 0.28 mL of 0.500 M Na₃Citrate solution were added to 95 mL of deionized water (NANOpure Infinity, Barstead), and the resulting solution was swirled by hand to mix. 5.00 mL of 12 nm silver seed solution (2 mM in total Ag) was added to the mixture and the solution was capped and swirled by hand to mix. The reaction mixture was heated to 95° C. for about 135 min and allowed to cool at room temperature for about an hour. The resulting 24 nm silver particles were stored at room temperature in the dark.

Gold seed particle synthesis: A household microwave oven (1350W, Panasonic) was used to prepare gold nanoparticles. Typically, 40 mL of an aqueous solution containing 0.500 mM HAuCl₄ and 2.0 mM sodium citrate in a glass bottle (100 mL) was heated to boiling in the microwave using the maximum power, followed by a lower power setting to keep the solution gently boiling for 5 min. 2.0 grams of PTFE boiling stones (6 mm, Saint-Gobain A1069103, through VWR) were added to the solution to promote gentle and efficient boiling. The resultant solutions had a rosy red color. Measurements by PCS showed that the gold solutions had a typical z-average of 13 nm with a polydispersity index of less than 0.04.

Particle size measurement: The sizes of silver and gold seed nanoparticles as well as Raman-active nanoclusters were determined by using Photon Correlation Spectroscopy (PCS, Zetasizer3 3000 HS or Nano-ZS, Malvern). All measurements were conducted at 25° C. using a He—Ne laser at 633 nm. Samples were diluted with DI water or 1 mM sodium citrate when necessary.

FIG. 8 graphs the zeta potential of 70 nm silver particles (50 μM in total silver) against the concentration of poly(2-metacryloxyethyltrimethylammonium bromide) (PQA). The addition of PQA to the silver particles reverses the surface charge of the silver colloids at concentrations of polymer as low as 1 ppm. At an even higher polymer concentration, such as 50 ppm, the polymer coated silver shows a zeta potential as high as +50 mV. A stable positively charged silver suspension was prepared at concentrations (1 mM Ag). It was found that mixing of equal volumes of silver colloids and PQA led to aggregation. However, a stable suspension was obtained when a small volume of silver colloids was added into a larger volume of polymer solution. Thus, silver colloids were first concentrated 5 times by centrifugation (7500 rpm for 10 min). Then 1 volume of the concentrated silver sol was rapidly distributed into 4 volumes of polymer solution. The final suspension contained 1 mM silver (about 5.7×10¹⁰ particles/mL) and 800 ppm PQA (about 1.2×10¹³ chains/mL). Zeta potential measurements confirmed that the colloids were positively charged and PCS size measurement did not reveal significant change in particle size compared with the original silver colloids, suggesting that there was no significant aggregation during mixing. It was also found that polyethyleneimine (PEI) could stabilize 24 nm Ag particles.

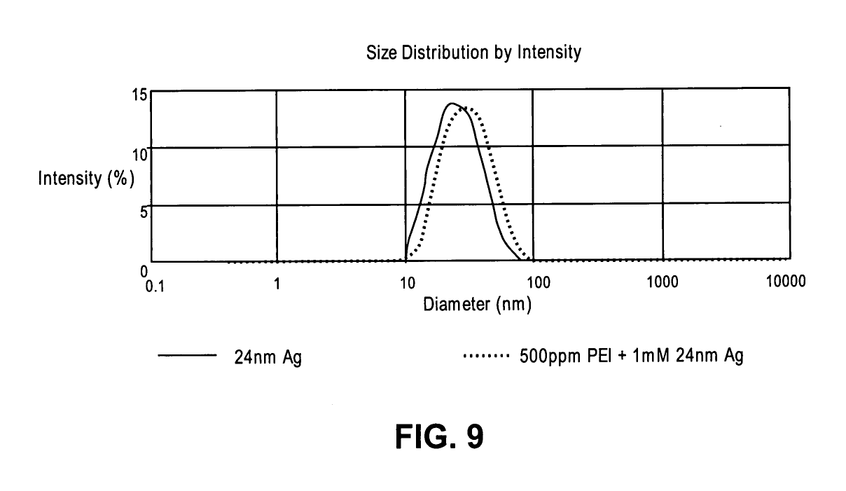

FIG. 9 provides a comparison of the size distribution of silver particles (2 mM of 24 nm Ag particles) before and after mixing with an equal volume of 1 mg/mL (1000 ppm) of polyethyleneimine (MW=10,000). It was found that the size increased by 2 nm and polydispersity remained the same. The size increase could be caused by the adsorption layer. There was no indication of aggregation found.

What is claimed is:

1.) A nanocluster of metal particles capable of displaying an enhanced Raman signature, wherein the enhanced Raman signature is produced from a plurality of Raman active organic molecules incorporated within the nanocluster, and wherein the nanocluster is comprised of a plurality of metal particles wherein one of the plurality of metal particles has a surface charge that is opposite that of another of the plurality of metal particles.

2.) The nanocluster of claim 1 wherein the metal particles are comprised of a metal selected from group consisting of silver, gold, copper, palladium, platinum, and aluminum.

3.) The nanocluster of claim 1 wherein the metal particles are comprised of silver or gold.

4.) The nanocluster of claim 1 wherein the nanocluster has an average diameter of about 20 nm to about 200 nm.

5.) The nanocluster of claim 1 wherein the nanocluster has an average diameter of about 50 nm to 150 nm.

6.) The nanocluster of claim 1 wherein the charge on a metal particle is created by a layer of cationic polymer adsorbed onto the nanoparticle.

7.) The nanocluster of claim 1 wherein the charge on a metal particle is created by a layer of anionic polymer adsorbed onto the nanoparticle.

8.) The nanocluster of claim 1 wherein the nanocluster contains two different organic compounds capable of being detected by Raman spectroscopy incorporated therein.

9.) The nanocluster of claim 1 wherein the nanocluster contains three different organic compounds capable of being detected by Raman spectroscopy incorporated therein.

10.) The nanocluster of claim 1 wherein the nanocluster is further comprised of a probe selected from the group consisting of antibodies, antigens, polynucleotides, oligonucleotides, receptors, carbohydrates, cofactors, and ligands.

11.) A nanocluster of metal particles capable of displaying an enhanced Raman signature, wherein the enhanced Raman signature is produced from a plurality of Raman active organic molecules incorporated within the nanocluster, wherein the nanocluster is comprised of a central metal particle having a surface charge, and wherein a plurality of metal particles having a surface charge that is opposite the surface charge of the central metal particle are in contact with the central metal particle.

12.) The nanocluster of claim 11 wherein the nanocluster of metal particles additionally comprises a second plurality of metal particles in contact with the first plurality of metal particles wherein the second plurality of metal particles has a surface charge that is opposite the surface charge of the first plurality of metal particles.

13.) The nanocluster of claim 11 wherein the metal particles are comprised of a metal selected from group consisting of silver, gold, copper, palladium, platinum, and aluminum.

14.) The nanocluster of claim 11 wherein the metal particles are comprised of silver or gold.

15.) The nanocluster of claim 11 wherein the nanocluster has an average diameter of about 20 nm to about 200 nm.

16.) The nanocluster of claim 11 wherein the charge on a metal particle is created by a layer of cationic polymer adsorbed onto the nanoparticle.

17.) The nanocluster of claim 11 wherein the charge on a metal particle is created by a layer of anionic polymer adsorbed onto the nanoparticle.

18.) The nanocluster of claim 11 wherein the nanocluster contains two different organic compounds capable of being detected by Raman spectroscopy incorporated therein.

19.) The nanocluster of claim 11 wherein the nanocluster contains three different organic compounds capable of being detected by Raman spectroscopy incorporated therein.

20.) The nanocluster of claim 11 wherein the nanocluster is further comprised of a probe selected from the group consisting of antibodies, antigens, polynucleotides, oligonucleotides, receptors, carbohydrates, cofactors, and ligands.

21.) A method of making a nanocluster of metal particles capable of displaying an enhanced Raman signal, wherein the enhanced Raman signal is produced from a plurality of Raman active organic molecules incorporated within the nanocluster, the method comprising contacting a solution containing metal nanoparticles having a negative surface charge with a solution of metal nanoparticles having a positive surface charge, wherein at least one type of the charged metal nanoparticles contains an attached Raman active organic molecule, under conditions that allow the positively charged metal particles to associate with the negatively charged metal particles and to form a nanocluster comprised of a plurality of oppositely charged metal particles.

22.) The method of claim 21 wherein the metal particles are comprised of at least one metal selected from group consisting of silver, gold, copper, palladium, platinum, and aluminum.

23.) The method of claim 21 wherein the metal particles are comprised of silver or gold.

24.) The method of claim 21 wherein the resulting nanocluster has an average diameter of about 20 nm to about 200 nm.

25.) The method of claim 21 wherein the charge on a metal particle is created by a layer of cationic polymer adsorbed onto the nanoparticle.

26.) The method of claim 21 wherein the charge on a metal particle is created by a layer of anionic polymer adsorbed onto the nanoparticle.

27.) The method of claim 21 wherein the resulting nanocluster contains two different organic compounds capable of being detected by Raman spectroscopy incorporated therein.

28.) The method of claim 21 also comprising coupling a probe selected from the group consisting of antibodies, antigens, polynucleotides, oligonucleotides, receptors, carbohydrates, cofactors, and ligands to the surface of the resulting nanocluster.
